(19) United States
(12) Patent Application Publication
(10) Pub. No.: US 2011/0040637 A1
(43) Pub. Date: Feb. 17, 2011

(54) E-business advertisement method with blog groups and system thereof

(76) Inventor: Nankuei Lin, Taipei (TW)

Correspondence Address: SAM CHEN, 7F-1, 293, ROOSEVELT ROAD, SEC 3, TAIPEI, TW

(21) Appl. No.: 12/540,378

(22) Filed: Aug. 13, 2009

(51) Int. Cl. G06Q 30/00

(52) U.S. Cl. 705/14.73

(57) ABSTRACT

An e-business advertisement system includes a plurality of e-business platforms; a work platform; and a plurality of web page servers. Each e-business platform includes a platform server and is connected to the Internet so that one of a plurality of remote terminals may access to the Internet for operating the e-business platform. The platform servers and the web page servers are interconnected via the work platform. E-business advertisement methods with blog groups are also provided.

### BACKGROUND OF THE INVENTION

1. Field of Invention

The invention relates to e-business and more particularly to an e-business advertisement method with blog groups and system thereof.

2. Description of Related Art

A blog is a type of personal diary posted on the Internet. Most blogs consist of small, plentiful entries. Topics posted on blogs may vary widely.

Conventionally, e-business is impossible by means of blog. This is because only data such as pictures and documents are typically transmitted by a web server. High cost and technological difficulties make e-business using blog almost infeasible.

Currently, there are many websites providing online shopping. Typically, an item and a brief description thereof are shown on a web page. Hence, a would-be buyer may not know details of a desired item by simply viewing the web page. This may greatly decrease interest of many would-be buyers. Many restrictions are also imposed on web pages provided by the online auction and shopping websites. This can further frustrate many would-be buyers. Thus, it is desirable to provide a novel e-business advertisement method with blog groups and system thereof in order to overcome the inadequacies of the prior art.

### SUMMARY OF THE INVENTION

It is therefore one object of the invention to provide an e-business advertisement method with blog groups.

It is another object of the invention to provide an e-business advertisement system with blog groups.

The above and other objects, features and advantages of the invention will become apparent from the following detailed description taken with the accompanying drawings.

### BRIEF DESCRIPTION OF THE DRAWINGS

FIG. 1 is a block diagram of an e-business advertisement system with blog groups according to the invention;

FIG. 2 is a block diagram of a first preferred embodiment of e-business advertisement system with blog groups according to the invention;

FIG. 3 is a detailed block diagram of the web page server of FIG. 2;

FIG. 4 is a block diagram of a second preferred embodiment of e-business advertisement system with blog groups according to the invention;

FIG. 5 is a detailed block diagram of the e-business platform of FIG. 4;

FIG. 6 is a block diagram of the home page of the blog according to the first preferred embodiment of the invention; and

FIG. 7 is a block diagram of the e-business platform according to the second preferred embodiment of the invention.

### DETAILED DESCRIPTION OF THE INVENTION

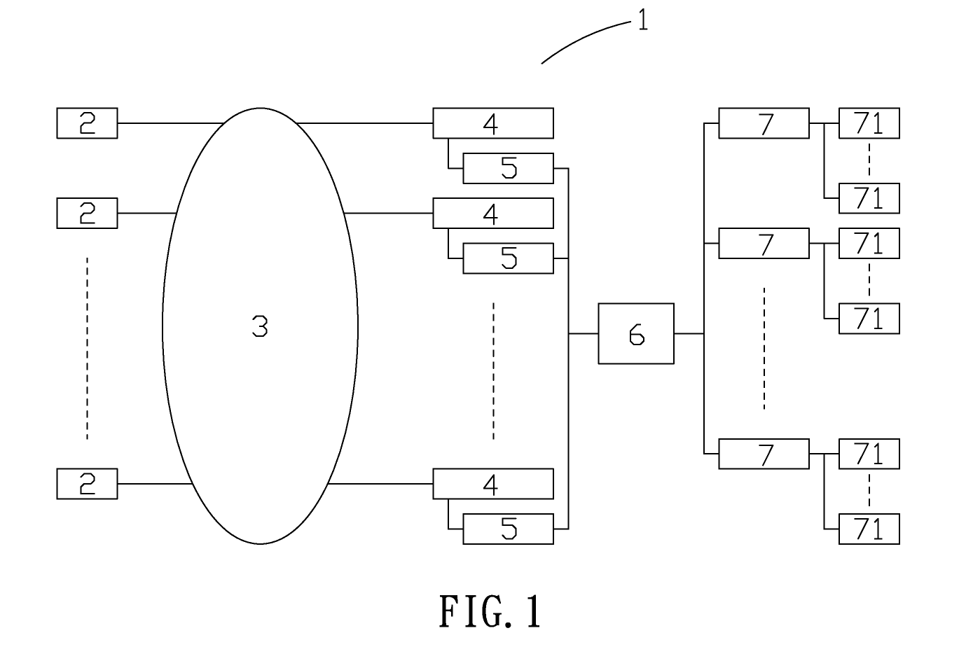

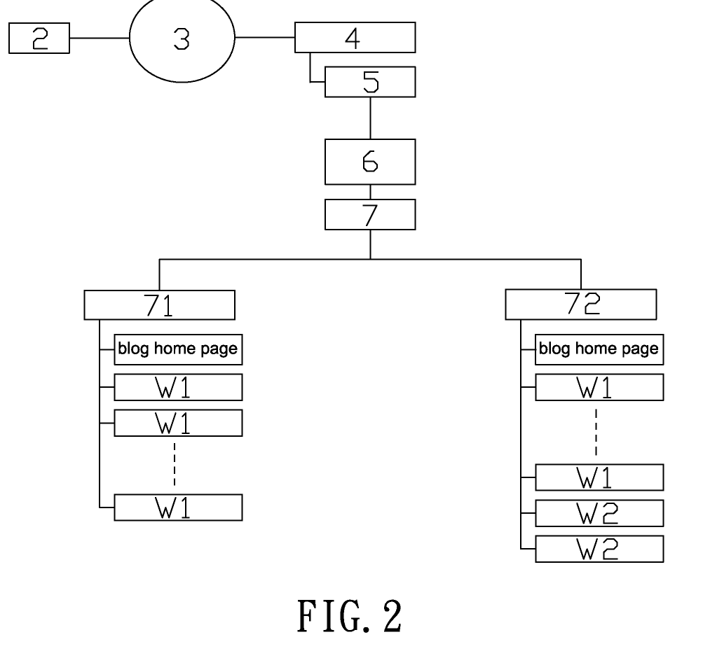

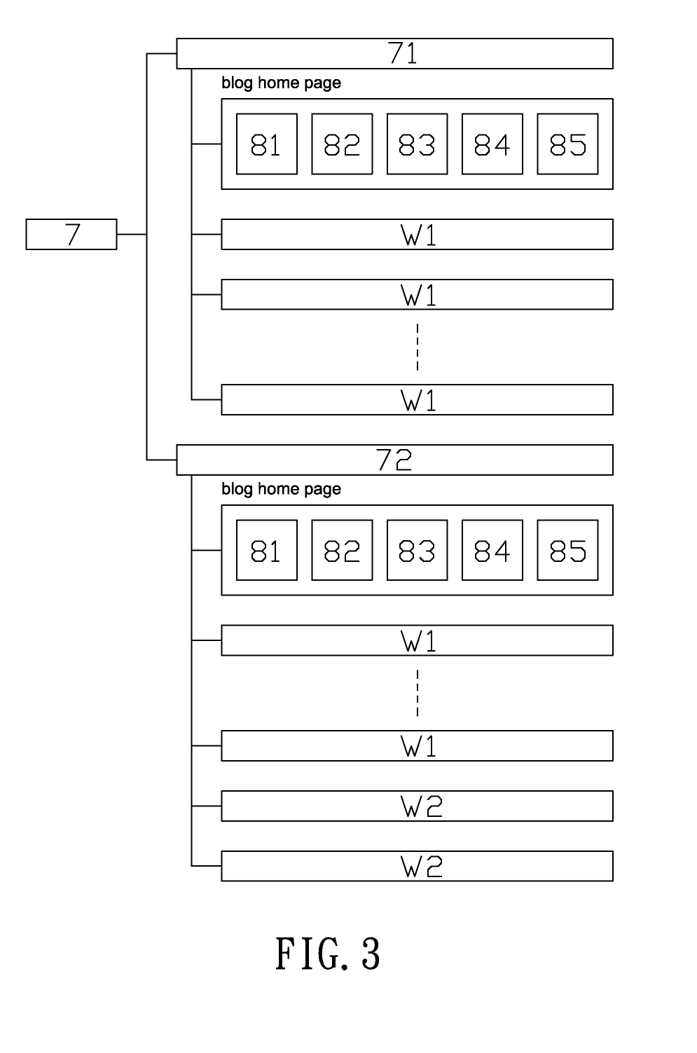

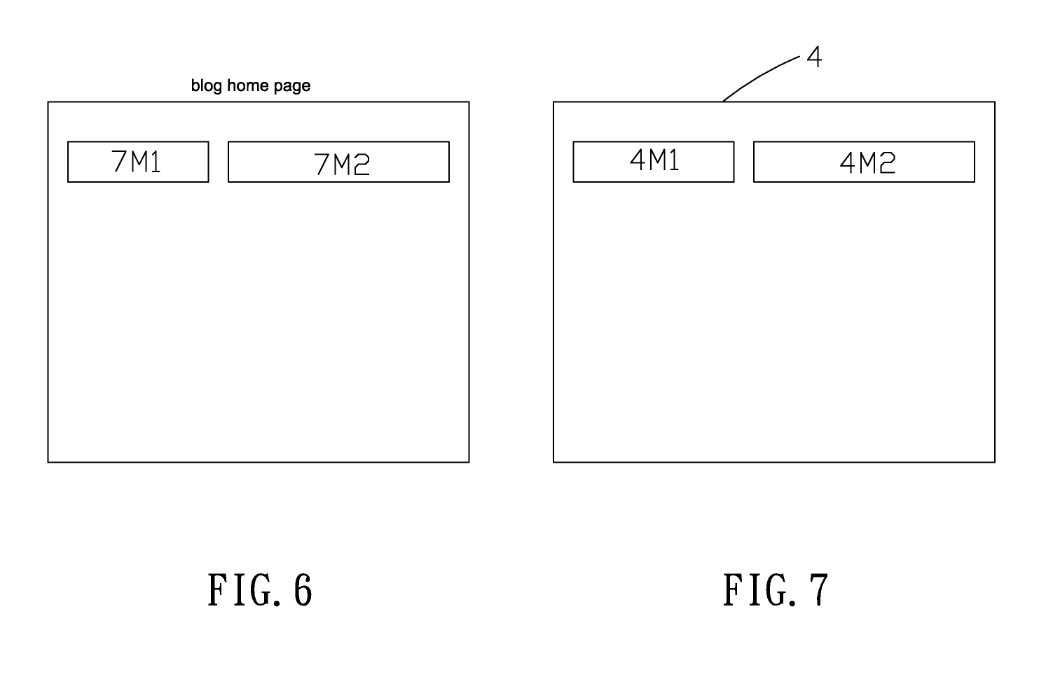

Referring to FIGS. 1 to 3 and 6, a first preferred embodiment of the invention is illustrated.

An e-business advertisement system 1 comprises a plurality of e-business platforms 4, a work platform 6, and a plurality of web page servers 7. The e-business platform 4 comprises a platform server 5. Each platform server 5 is connected to the Internet 3 via the e-business platform 4. The Internet 3 is in turn connected to a plurality of remote terminals 2 for data communications. The platform servers 5, the work platform 6, and the web page servers 7 are interconnected for data communications.

An e-business advertisement method with blog groups for use in the e-business advertisement system 1 comprises connecting a user of the remote terminal 2 to the Internet 3 which is in turn connected to the platform server 5 via the e-business platform 4; typing personal data of the user on the remote terminal 2 to apply for membership of the e-business platform 4; and allowing the user to access the e-business platform 4 after successfully obtaining the membership of the e-business platform 4.

A seller is required to register with the e-business platform 4 in order to obtain a salesperson membership of the e-business platform 4. That is, a seller having the salesperson membership is regarded as a salesperson.

A seller having the salesperson membership may register with the e-business platform 4. Next, the platform server 5 associated with the e-business platform 4 will be connected to the web page server 7 via the work platform 6. Next, one or more web pages of a blog 71 about the seller will be created by the web page server 7. An item description page W1 about each item to be sold by the seller will be created by the blog 71. Details including pictures and detailed description of the item are also included in the item description page W1 so that a person may link same for retrieving information therefrom.

The e-business advertisement method with blog groups further comprises a blog items interactive mode including creating a blog module 7M1 on a home page of the blog 71 of the salesperson. Thus, the salesperson may have the right of using the blog module 7M1. The salesperson associated with the e-business platform 4 may create an association blog 72 for the blog of another salesperson by setting the blog module 7M1.

The blog items interactive mode further comprises causing the e-business platform 4 to create a plurality of blog items display links on the web pages of the blog 71 of the salesperson. The blog items display link comprises a plurality of links each connecting to pictures and detailed description of a corresponding item description page W1 belonging to the association blog 72 of the salesperson (or the other salesperson).

The e-business advertisement method with blog groups further comprises a blog items management mode including creating a blog items management module 7M2 on a home page of the blog 71 of the salesperson. Thus, the salesperson may have the right of using the blog items management module 7M2. A salesperson associated with the e-business platform 4 may link pictures and detailed description of an item description page W1 belonging to the blog 71 of the salesperson with a corresponding item description page W1 by setting the blog items management module 7M2. Thereafter, a plurality of blog items display links on the web pages of the blog 71 of the salesperson (or the association blog 72 of the salesperson) can be created.

The blog items management mode further comprises allowing the salesperson to set a use status of the item description page W1 on the blog 71 of the salesperson as preferential price confirmation, special price confirmation, or exclusive price confirmation status based on different blog items display links by setting the blog items management module 7M2. A salesperson may link pictures and detailed description of an item description page W1 belonging to the blog 71 of the salesperson with a corresponding item description page W1. Further, a link is created on the blog items display link of the web pages of blog 71 of the salesperson.

A salesperson may set the blog items management module 7M2 to submit a joint sale application if the salesperson wants to place the item description page W1 of the blog 71 thereof on the blog items display link of the web pages of the association blog 72 of the salesperson. Next, the salesperson of the association blog 72 may allow the joint sale application or not based on the setting of the blog items management module 7M2. The salesperson of the association blog 72 will do the following things if the joint sale application is allowed. The use status of the item description page W1 of the blog 71 of the salesperson will be set as joint sale application confirmation status. Moreover, the item description page W1 of the blog 71 of the salesperson will be combined with the web pages of the association blog 72 of the salesperson to create a joint sale item description page W2. The salesperson owning the association blog 72 may link pictures and detailed description of a joint sale item description page W2 belonging to the association blog 72 of the salesperson with a corresponding joint sale item description page W2. Further, a link is created on the blog items display link of the web pages of the association blog 72 of the salesperson.

A salesperson may link pictures and detailed description of an item description page W1 belonging to the blog 71 of the salesperson with a corresponding item description page W1 if the salesperson wants to place the item description page W1 of the blog 71 thereof on the blog items display link of the web pages of the association blog 72 of the salesperson. The use status of the item description page W1 of the blog 71 of the salesperson will be set as share confirmation status by setting the association blog 72. The salesperson owning the association blog 72 may link pictures and detailed description of an item description page W1 belonging to the association blog 72 of the salesperson with a corresponding item description page W1. Further, a link is created on the blog items display link of the web pages of the association blog 72 of the salesperson.

The use status of the item description page W1 of the blog 71 of the salesperson can be set as more than one status. The blog items display link comprises an item preferential price link 81, an item special price link 82, an item exclusive price link 83, an item joint sale link 84, and an item share link 85.

A user may select the item preferential price link 81 to access pictures and detailed description of an item description page W1 belonging to the blog of the salesperson. Thus, detailed description about high price items sold by the salesperson can be shown. The use status of the item description page W1 can be set as a preferential price confirmation status.

A user may select the item special price link 82 to access pictures and detailed description of an item description page W1 belonging to the blog of the salesperson. Thus, detailed description about low price items sold by the salesperson can be shown. The use status of the item description page W1 can be set as a special price confirmation status.

A user may select the item exclusive price link 83 to access pictures and detailed description of an item description page W1 belonging to the blog of the salesperson. Thus, detailed description about all items sold by the salesperson can be shown. The use status of the item description page W1 can be set as an exclusive price confirmation status.

A user may select the item joint sale link 84 to access pictures and detailed description of a joint sale item description page W2 belonging to the blog 71 of the salesperson. Thus, all items sold by the salesperson owning the association blog 72 can be assigned to the specific salesperson for sale with detailed description about the items being shown.

A user may select the item share link 85 to access pictures and detailed description of an item description page W1 belonging to the association blog 72 of the salesperson. Thus, detailed description about all items sold by the salesperson owning the association blog 72 can be shown. The use status of the item description page W1 can be set as a share confirmation status.

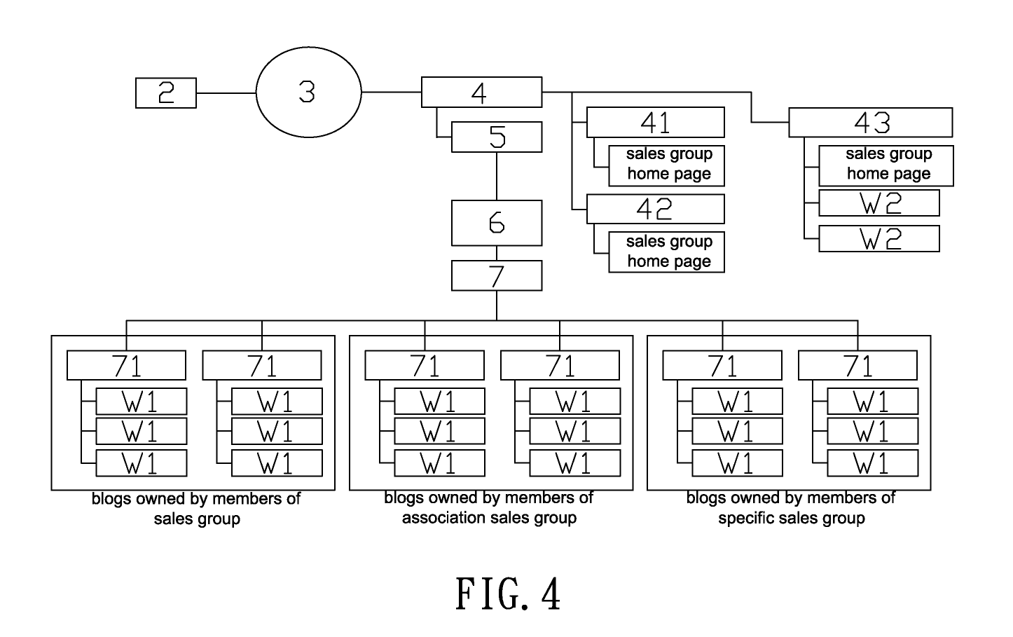

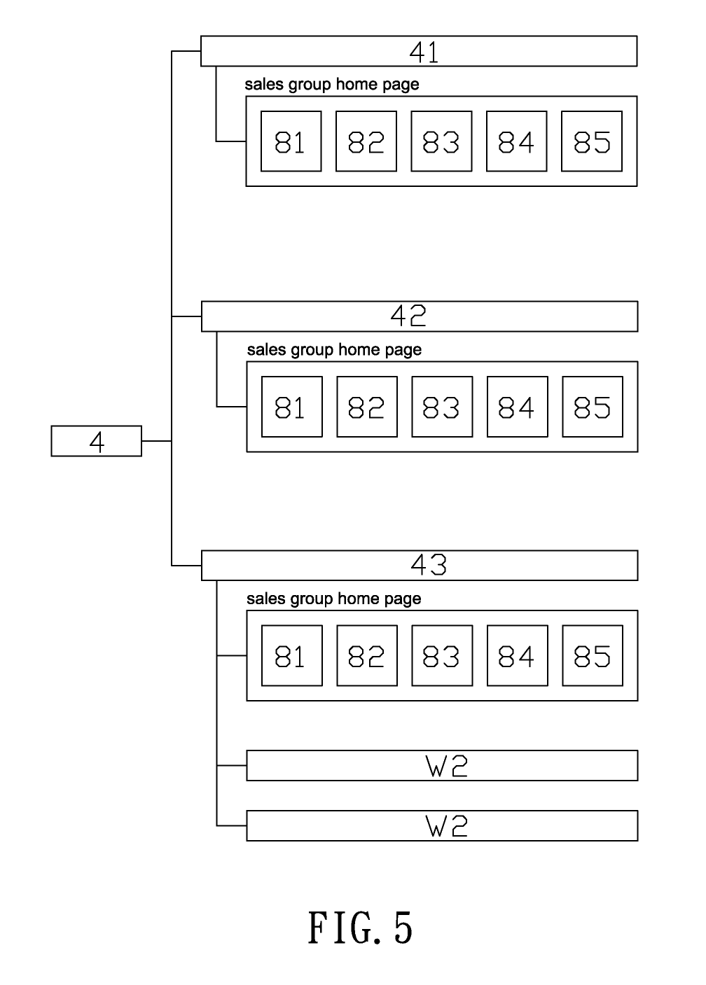

Referring to FIGS. 1, 4, 5, and 7, a second preferred embodiment of the invention is illustrated.

An e-business advertisement system 1 comprises a plurality of e-business platforms 4, a work platform 6, and a plurality of web page servers 7. The e-business platform 4 comprises a platform server 5. Each platform server 5 is connected to the Internet 3 via the e-business platform 4. The Internet 3 is in turn connected to a plurality of remote terminals 2 for data communications. The platform servers 5, the work platform 6, and the web page servers 7 are interconnected for data communications.

An e-business advertisement method with blog groups for use in the e-business advertisement system 1 comprises connecting a user of the remote terminal 2 to the Internet 3 which is in turn connected to the platform server 5 via the e-business platform 4; typing personal data of the user on the remote terminal 2 to apply for membership of the e-business platform 4; and allowing the user to access the e-business platform 4 after successfully obtaining the membership of the e-business platform 4.

A seller is required to register with the e-business platform 4 in order to obtain a salesperson membership of the e-business platform 4. That is, a seller having the salesperson membership is regarded as a salesperson.

A seller having the salesperson membership may register with the e-business platform 4. Next, the platform server 5 associated with the e-business platform 4 will be connected to the web page server 7 via the work platform 6. Next, one or more web pages of a blog 71 about the seller will be created by the web page server 7. An item description page W1 about each item to be sold by the seller will be created by the blog 71. Details including pictures and detailed description of the item are also included in the item description page W1 so that a person may link same for retrieving information therefrom.

The e-business advertisement method with blog groups further comprises a sales group mode including creating a sales group module 4M1 on the e-business platform 4. Thus, the salesperson may have the right of using the sales group module 4M1. The salespersons associated with the e-business platform 4 may create a sales group 41 by setting the sales group module 4M1. One of the salespersons is assigned as the manager of the sales group. Other salespersons may join the sales group as members by setting the sales group module 4M1. The members of the sales group are also members of the sales group associated with the e-business platform 4.

The salespersons associated with the e-business platform 4 may join one or more sales groups 41 by setting the sales group module 4M1. Alternatively, another sales group 41 can be created by the salespersons associated with the e-business platform 4 The salespersons associated with the e-business platform 4 and having the memberships of the sales group are members of the sales group. The sales groups associated with the e-business platform 4 may assign another sales group as an association sales group 42 by setting the sales group module 4M1.

The sales group mode further comprises causing the e-business platform 4 to create a plurality of group items display links associated with a sales group 41 on the web pages of the e-business platform 4. The group items display link comprises a plurality of links each connecting to pictures and detailed description of a corresponding item description page W1 belonging to the blog of a member of a sales group or an association sales group.

The e-business advertisement method with blog groups further comprises a group items management mode including creating a sales group items management module 4M2 on the e-business platform 4. Thus, members of the sales group may have the right of using the sales group items management module 4M2. A member of the sales group associated with the e-business platform 4 may link pictures and detailed description of an item description page W1 belonging to the blog 71 of the member of the sales group with a corresponding item description page W1 by setting the sales group items management module 4M2. Thereafter, a plurality of group items display links on the web pages of the e-business platform 4 can be created.

The sales group items management mode further comprises allowing a member of the sales group to submit a preferential price application, a special price application, or an exclusive price application by setting the sales group items management module 4M2 if the member of the sales group wants to link pictures and detailed description of an item description page W1 belonging to the blog 71 of the member of the sales group with a corresponding item description page W1 in order to link with a plurality of group items display links associated with a sales group 41 on the web pages of the e-business platform 4. Next, the manager of the sales group 41 may allow the preferential price application, the special price application, or the exclusive price application or not based on the setting of the sales group items management module 4M2. The manager of the sales group will do the following things if one of the above applications is allowed. A use status of the item description page W1 on the blog 71 of a member of the sales group is set as preferential price confirmation, special price confirmation, or exclusive price confirmation status by setting the sales group items management module 4M2 based on different group items display links. Pictures and detailed description of an item description page W1 belonging to the blog 71 of the salesperson with a corresponding item description page W1 will be linked with the group items display link associated with a sales group 41 on the web pages of the e-business platform 4.

A member of the sales group may set the sales group items management module 4M2 to submit a joint sale application if the member of the sales group wants to place the item description page W1 of the blog 71 thereof on the group items display link of a specific sales group 43 on the web pages of the e-business platform 4. Next, the manager of the specific sales group 43 may allow the joint sale application or not based on the setting of the sales group items management module 4M2. The manager of the specific sales group 43 will do the following things if the joint sale application is allowed. The use status of the item description page W1 of the blog 71 of the member of the sales group will be set as joint sale application confirmation status. Moreover, the item description page W1 of the blog 71 of the member of the sales group will be combined with the web pages of the specific sales group 43 to create a joint sale item description page W2 on the e-business platform 4. Pictures and detailed description of a joint sale item description page W2 belonging to the specific sales group 43 on the web pages of the e-business platform 4 may be linked with a corresponding joint sale item description page W2. Further, a link is created on the group items display link of the specific sales group 43 on the web pages of the e-business platform 4.

The manager of the sales group 41 may link pictures and detailed description of an item description page W1 belonging to the blog 71 of the member of the sales group with a corresponding item description page W1 if the sales group 41 wants to place the item description page W1 of the blog 71 thereof on the group items display link of the association sales group 42 on the web pages of the e-business platform 4. Next, the manager of the association sales group 42 may allow a share application of the sales group 41 or not based on the setting of the sales group items management module 4M2. The manager of the association sales group 42 will do the following things if the share application is allowed. The use status of the item description page W1 of the blog 71 of the member of the sales group 41 will be set as share confirmation status by setting the sales group items management module 4M2. Moreover, pictures and detailed description of the item description page W1 belonging to the blog 71 of the member of the sales group 41 will be linked with a corresponding item description page W1. Further, a link is created on the group items display link of the association sales group 42 on the web pages of the e-business platform 4.

The use status of the item description page W1 of the blog 71 of the member of the sales group can be set as more than one status. The group items display link comprises an item preferential price link 81, an item special price link 82, an item exclusive price link 83, an item joint sale link 84, and an item share link 85.

A user may select the item preferential price link 81 to access pictures and detailed description of an item description page W1 belonging to the blog 71 of the member of the sales group 41. Thus, detailed description about high price items sold by the member of the sales group 41 can be shown. The use status of the item description page W1 can be set as a preferential price confirmation status.

A user may select the item special price link 82 to access pictures and detailed description of an item description page W1 belonging to the blog 71 of the member of the sales group 41. Thus, detailed description about low price items sold by the member of the sales group 41 can be shown. The use status of the item description page W1 can be set as a special price confirmation status.

A user may select the item exclusive price link 83 to access pictures and detailed description of an item description page W1 belonging to the blog 71 of the member of the sales group 41. Thus, detailed description about all items sold by the member of the sales group 41 can be shown. The use status of the item description page W1 can be set as an exclusive price confirmation status.

A user may select the item joint sale link 84 to access pictures and detailed description of a joint sale item description page W2 belonging to the blog 71 of the member of the sales group 41. Thus, all items sold by members of other sales groups can be assigned to the sales group 41 for sale with detailed description about the items being shown.

A user may select the item share link 85 to access pictures and detailed description of an item description page W1 belonging to the members of the association sales group 42. Thus, detailed description about all items sold by the members of the association sales group 42 can be shown. The use status of the item description page W1 can be set as a share confirmation status.

While the invention herein disclosed has been described by means of specific embodiments, numerous modifications and variations could be made thereto by those skilled in the art without departing from the scope and spirit of the invention set forth in the claims.

What is claimed is:

1. An e-business advertisement method for use in an e-business advertisement system comprising a plurality of e-business platforms, a work platform, and a plurality of web page servers wherein each of the e-business platforms comprises a platform server and is connected to the Internet so that one of a plurality of remote terminals may access to the Internet for operating the e-business platform, and the platform servers and the web page servers are interconnected via the work platform, the e-business advertisement method comprising:
connecting a user of the remote terminal to the Internet;
sending personal data of the user to the e-business platform for applying for membership of the e-business platform;
activating a blog items interactive mode including creating a blog module on a home page of a blog of a salesperson, allowing the salesperson to use the blog module, and allowing the salesperson associated with the e-business platform to create an association blog for another salesperson by setting the blog module; and
activating a blog items management mode including creating a blog items management module on the home page of the blog of the salesperson, allowing the salesperson to use the blog items management module, allowing the salesperson associated with the e-business platform to link pictures and a detailed description of an item description page belonging to the blog of the salesperson with a corresponding item description page by setting the blog items management module, and creating a plurality of blog items display links on the blog of the salesperson.

2. The e-business advertisement method of claim 1, wherein the blog items interactive mode further comprises causing the e-business platform to create a plurality of blog items display links on the blog of the salesperson, each of the blog items display links comprising a plurality of links each connecting to pictures and a detailed description of a corresponding item description page belonging to the association blog of the salesperson.

3. The e-business advertisement method of claim 1, wherein the blog items management mode further comprises allowing the salesperson to set a use status of the item description page on the blog of the salesperson as a preferential price confirmation, a special price confirmation, or an exclusive price confirmation status based on the blog items display links by setting the blog items management module, allowing the salesperson to link the pictures and the detailed description of the item description page belonging to the blog of the salesperson with a corresponding item description page, and creating a link on the blog items display link of the blog of the salesperson.

4. The e-business advertisement method of claim 1, wherein each of the blog items display links comprises an item preferential price link, an item special price link, an item exclusive price link, an item joint sale link, and an item share link.

5. An e-business advertisement method for use in an e-business advertisement system comprising a plurality of e-business platforms, a work platform, and a plurality of web page servers wherein each of the e-business platforms comprises a platform server and is connected to the Internet so that one of a plurality of remote terminals may access to the Internet for operating the e-business platform, and the platform servers and the web page servers are interconnected via the work platform, the e-business advertisement method comprising:
connecting a user of the remote terminal to the Internet;
sending personal data of the user to the e-business platform for applying for membership of the e-business platform;
activating a sales group mode including creating a sales group module on the e-business platform, allowing one of a plurality of salespersons to use the sales group module, and allowing the salesperson associated with the e-business platform to create a sales group by setting the sales group module wherein one salesperson is assigned as a manager of the sales group; and
activating a group items management mode including creating a sales group items management module on the e-business platform, allowing members of the sales group to use the sales group items management module, allowing one member of the sales group associated with the e-business platform to link pictures and a detailed description of an item description page belonging to the blog of one member of the sales group with a corresponding item description page by setting the sales group items management module, and creating a plurality of group items display links on web pages of the e-business platform.

6. The e-business advertisement method of claim 5, wherein the sales group mode further comprises causing the e-business platform to create a plurality of group items display links associated with a sales group on the web pages of the e-business platform, each of the group items display links comprising a plurality of links each connecting to pictures and a detailed description of a corresponding item description page belonging to the blog of one member of the sales group or an association sales group.

7. The e-business advertisement method of claim 5, wherein the sales group items management mode further comprises allowing one member of the sales group to submit a preferential price application, a special price application, or an exclusive price application by setting the sales group items management module if the member of the sales group wants to link the pictures and the detailed description of the item description page belonging to the blog of the member of the sales group with a corresponding item description page in order to link with a plurality of group items display links associated with the sales group on the web pages of the e-business platform, allowing the manager of the sales group to allow the preferential price application, the special price application, or the exclusive price application or not based on the setting of the sales group items management module, linking the pictures and the detailed description of the item description page belonging to the blog of the salesperson with a corresponding item description page, and creating a link of the sales group on the web pages of the e-business platform.

8. The e-business advertisement method of claim 5, wherein each of the group items display links comprises an item preferential price link, an item special price link, an item exclusive price link, an item joint sale link, and an item share link.

9. An e-business advertisement system comprising:
a plurality of e-business platforms;
a work platform; and
a plurality of web page servers,
wherein each of the e-business platforms comprises a platform server and is connected to the Internet so that one of a plurality of remote terminals may access to the Internet for operating the e-business platform; and
wherein the platform servers and the web page servers are interconnected via the work platform.
